(19) United States
(12) Patent Application Publication
(10) Pub. No.: US 2004/0193523 A1
(43) Pub. Date: Sep. 30, 2004

(54) Providing stock shares having associated rights to a cruise

(76) Inventors: Jack E. Roberts, Salt Lake City, UT (US); Edwin V. Davis II, Ogden, UT (US); Marilyn H. Roberte, Salt Lake City, UT (US)

Correspondence Address: Kirton & McConkie, 1800 Eagle Gate Tower, 60 East South Temple, Salt Lake City, UT, 84111, US

(21) Appl. No.: 10/696,542

(22) Filed: Oct. 29, 2003

Related U.S. Application Data
(60) Provisional application No. 60/423,228, filed on Nov. 1, 2002.

(51) Int. Cl. G06F 17/60

(52) U.S. Cl. 705/36

(57) ABSTRACT

Systems and methods for selectively providing stock shares that entitle rights to use a cruise ship property and/or amenities associated with the property. A management entity oversees and selectively schedules use of the property according to individual stock shares. The stock is purchased through a travel agent. In one implementation, the use is the dividend provided to the stockholder. In another implementation the use schedule is created by receiving use requests from stockholders and scheduling use of the property according to which stockholder first requested the property for the scheduled use period. In another implementation, a lottery system is used to assign use dates or periods to the individual shareholders. In yet another implementation, preference to use dates/periods is made based on the number of stock shares or the type of stock shares (e.g., shares of a preferred stock) owned by the stockholder.

### PRIORITY APPLICATIONS

This application claims priority to provisional patent application 60/423,228; filed Nov. 1, 2002, entitled “METHOD FOR SELLING TIMESHARES THROUGH TRAVEL AGENTS; and to utility patent application Ser. No. 10/190,442, filed Jul. 5, 2002, entitled “PROVIDING STOCK-SHARES HAVING ASSOCIATED RIGHTS TO USE A PROPERTY,” both listing Jack Roberts as the inventor.

### BACKGROUND OF THE INVENTION

1. Field of the Invention

The present invention relates to issuing stock shares, which shares confer to the owners thereof the rights to occupy and use one or more staterooms and associated services and amenities. More particularly, the present invention relates to systems and methods for providing stock shares that represent ownership in a corporation that owns or controls or has the right to use at least a portion of one or more cruise ships wherein the stock shares entitle the stockholder rights to use the cruise ships (e.g., to occupy a cabin of one of the cruise ships during a cruise), and wherein the stock shares are sold through one or more qualified travel agents.

2. Background and Related Art

A variety of alternatives relating to rights to use and/or occupy vacation property are available to individuals. One option is to purchase the property. This option may be prohibitively expensive, especially if use of the property by the individual is infrequent. This is especially true in the cruise ship environment.

Another alternative relating to rights to use and/or occupy property in the vacation industry is renting. This alternative is particularly popular for vacationers since it is not as restrictive as ownership of the property. For example, vacationers may rent a commercial establishment (e.g., a room at a hotel or motel) or purchase a ticket for transportation and/or accommodation (e.g., purchase a one week cruise vacation). However, while this alternative is not as financially burdensome, it has proven to introduce restrictions due to availability of rooms, etc. A third alternative is to purchase a timeshare. This somewhat ameliorates the availability problems and does not require as much financial commitment.

Timeshares have proven to be expensive due to the sales efforts typically employed to market and sell the individual timeshares. It has been estimated that up to 55 percent of the purchase price may be ascribed to marketing costs. This built-in burden often results in severe depreciation when the timeshares are resold. Developers typically are responsible for the initial marketing and sales, with management being conveyed to a professional management company upon the sale of the majority of the timeshares. In order to recoup their marketing investment, developers usually require a down payment (e.g., 10%) of the timeshare purchase price. The remaining portion of the purchase price is generally financed through a company subsidiary or a third-party lender. This financing may be at an interest rate that is higher than conventional mortgages because the delinquency rate for timeshare purchases has traditionally been higher and the property securing the loan can be a depreciating asset. The depreciation can occur immediately after a timeshare is purchased, since developers must add the costs of marketing to the construction costs. These marketing costs are not reflected in the value of the property after the initial purchase.

Thus, while alternatives relating to obtaining a right to use and/or occupy vacation property are available to individuals, challenges still exist with available alternatives.

Accordingly, it would be an improvement in the art to augment or even replace current alternatives with other alternatives for individuals.

### SUMMARY OF THE INVENTION

The present invention relates to providing stock shares having associated rights to a cruise. More particularly, the present invention relates to systems and methods for providing stock shares that represent ownership in at least a portion of one or more cruise ships by an entity, wherein the dividend of the stock shares entitles the stockholder rights to use the cruise ships (e.g., to occupy a cabin of one of the cruise ships during a cruise), and wherein the stock shares are sold through one or more qualified travel agents.

Implementation of the present invention takes place in association with the creation of stock shares that represent ownership in an entity that has ownership in one or more cruise ships. The entity may issue use rights to occupy and/or use the cruise ships as an annual dividend which may be issued in the form of point, credits or some other representation of value that can be redeemed for the right-to-use the property, or the rights can be accrued through another mechanism such as ownership in a property management company or directly through purchase of the stock.

In one implementation, use rights to occupy and/or use a cruise ship are provided as a stock dividend. The stock shares are issued by an entity that has ownership in one or more cruise ships, are marketed through one or more qualified travel agents and sold privately or publicly. Customers of the travel agents purchase the stock shares and receive dividends, which allow utilization of the cruise ships.

In a further implementation, a management entity oversees and selectively schedules use of the cruise ships according to benefits such as dividends declared. For example, in one implementation, the use schedule is created by receiving use requests from stockholders and scheduling use of cabins of the cruise ships according to which stockholder first requested the property for the scheduled date(s). In another implementation, a lottery system is used to assign use dates or periods to the individual stockholders. In yet another implementation, preference to use dates/periods is made based on the number of stock shares owned. Furthermore, in another implementation, a preferred stock is issued to provide a preference in using cruise ship property (e.g., cabins, equipment, restaurants, etc.). Moreover, implementation of the present invention embraces the use of fixed, floating, and/or rotating techniques for providing use of cruise ship property.

Another embodiment of the present invention disseminates “points” or “credits” for stock ownership. The points or credits are convertible into use rights for the ships. For example, an owner could save points for several years and then redeem the points for several weeks of cruising or for a higher valued cruise trip. The points could alternatively be redeemed for several cabins during the same week.

Implementation of the present invention also embraces the exchange of stock shares by individuals. In one implementation, the exchange takes place through a public exchange. In another implementation, the exchange occurs over a computer network, such as the Internet, as will be discussed herein.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative computer device for use in managing and/or scheduling use of a property;

FIG. 2 illustrates a representative networked system configuration for use in providing an electronic exchange, in calendaring use of a property, and/or overseeing entitlements to use a property;

FIG. 3 is a flow chart that provides a representative embodiment for allocating stock shares, expenses, and dividends corresponding to use of a property;

FIG. 4 is a flow chart that provides a representative embodiment for selectively using rights obtained through the purchase of stock; and

FIG. 5 is a flow chart that provides a representative embodiment for providing, purchasing, and allocating stock shares through a travel agent for utilization of cruise ship property and/or amenities.

### DETAILED DESCRIPTION OF THE INVENTION

The present invention relates to providing stock shares having associated rights to use of a cruise ship. More particularly, the present invention relates to systems and methods for providing stock shares that represent ownership in and/or the right to use at least a portion of one or more cruise ships by an entity, wherein the benefit, such as a dividend, of the stock shares entitles the stockholder to use the cruise ships (e.g., to occupy a cabin of one of the cruise ships during a cruise), and wherein the stock shares are sold through one or more qualified travel agents.

In the disclosure and in the claims the terms “use” or “right to use” shall refer to rights obtained as benefits, such as dividends ancillary to stock purchase or directly through the issuance of stock shares to occupy, enjoy, or otherwise have the enjoyment of a property, whether real property or personal property, and/or amenities associated with a cruise ship property. Examples of such cruise ship properties and amenities associated with cruise ship property include, but are not limited to, cabins, clubs, restaurants, recreational facilities, water sports, exercise facilities, entertainment facilities, swimming pools, pro shops, entertainment services, automobiles, mass transit, sports vehicles, etc.

As used herein, “floating structure” shall mean a watercraft large enough to serve as a structure. Examples are cruise ships, houseboats, barges, floating lodges, and other floating structures.

As used herein, the terms “cabin,” “rooms” or “stateroom” are used interchangeably.

As used herein, “entity” shall mean a corporation, company or other form of business organization that may or may not have as its reason for existence the ownership of real or personal property. The current invention anticipates that some entities that have had trouble attracting investors may utilize the invention to attract purchases of stock.

As used herein, the term “user” may refer to the owner of the stock who chooses to occupy or use the cruise ship property and/or any amenity thereof under the terms of the benefit or dividend. User may also apply to a third party who gains a right to use the property through an exchange of rights with another property or owner.

Embodiments of the present invention take place in association with the creation of stock shares that represent ownership in an entity and have as an annual benefit or dividend or right to use cruise ship property. Moreover, embodiments of the present invention embrace the issuance of stock shares to use amenities of the cruise ship property. In one embodiment, a management entity oversees and selectively schedules use of the property according to ownership of individual stock shares. In a further embodiment, a schedule is created by receiving requests from stockholders and scheduling the use of the property according to which stockholder first requested the property for the scheduled period of time. In another embodiment, a lottery system is used to assign use dates or periods to the individual shareholders. In yet another embodiment, preference to use dates/periods is given based on the number of stock shares owned and/or based on ownership of a preferred stock. The preferred stock may be one class, or several classes having different use rights associated with each class.

Embodiments of the present invention embrace the exchange of use dates/periods. Further, embodiments of the present invention also embrace the exchange of stock shares by individuals. The exchange may be at a public exchange or through an electronic exchange as provided herein

The following disclosure of the present invention is grouped into three subheadings, namely “Managing and Overseeing Use,” “Using Stock Shares to Entitle Use,” and “Utilizing a Qualified Agent.” The utilization of the subheadings is for convenience of the reader only and is not to be construed as limiting in any sense.

### Managing and Overseeing Use

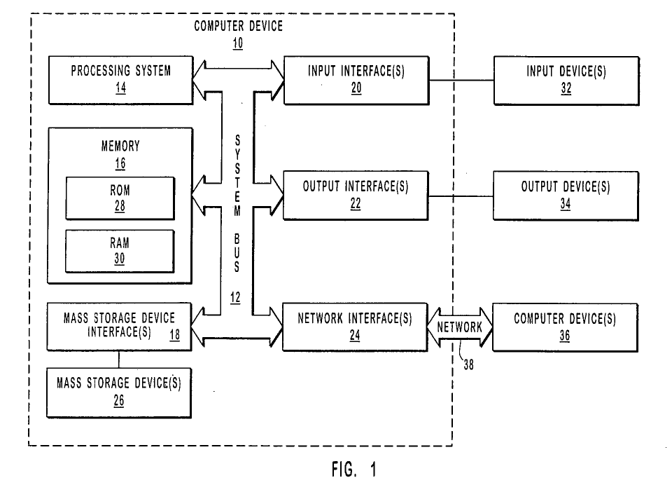

While not required, some of the embodiments of the present invention embrace the use of one or more computer devices to selectively manage the rights to use one or more cruise ship properties and/or amenities or otherwise perform methods disclosed herein, wherein the right to use is allocated by stock ownership. Accordingly, FIG. 1 and the corresponding discussion are intended to provide a general description of a suitable computer device for use in accordance with the present invention. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing an embodiment of the present invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

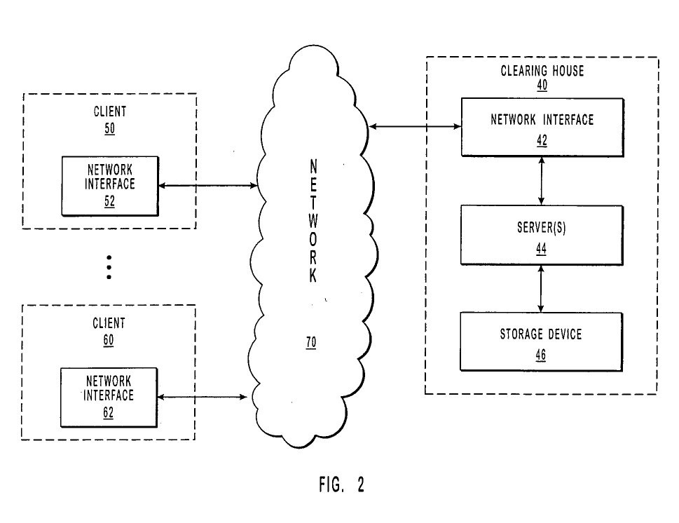

While those skilled in the art will appreciate that the invention may be practiced in networked computing environments with many types of computer system configurations, FIG. 2 represents an embodiment of the present invention that enables electronic exchange of entitlements to use a cruise ship property/amenity, requests for use of a cruise ship property/amenity, scheduling of use, management of stock shares, identification of use, and the like across a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

The emergence of the Internet has enabled a very large number of computer devices across the world to be connected across a wide area network in order to participate in global communication. The following is a discussion of an embodiment of the present invention that includes a plurality of clients, illustrated as clients 50 and 60, that are connected to clearinghouse 40 across the Internet, illustrated as network 70, in order to selectively manage entitlement rights for the use of a property.

In one embodiment, clients 50 and 60 each include a network interface (respectively illustrated as network interfaces 52 and 62) and a Web Browser (not shown). Network interface 52 is a communication mechanism that allows a client, such as client 50 to communicate to clearinghouse 40 by a network 70, such as the Internet. The Web Browsers are application programs that allow information to be displayed on a monitor device as text and/or graphics in the form of a web page. A browser allows for the entering of uniform resource locator (“URL”) to thereby access the corresponding web page. Therefore, clients 50 and 60 may independently access a web page that enables the transmission of cruise ship property/amenity information necessary to selectively manage and/or exchange entitlements to use cruise ship property/amenity.

Clearinghouse 40 includes network interface 42, application servers 44, and storage device 46. Network interface 42 is a communication mechanism that allows clearinghouse 40 to communicate with one or more clients by network 70. Servers 44 include one or more servers for processing and/or preserving information for the management and/or exchange of rights to use. Storage device 46, which may be internal or external to servers 44, includes one or more storage devices for preserving information, such as transactional information, scheduling information and/or stockholder information to perform the methods enclosed herein.

In accordance with embodiments of the present invention, a user at a client may selectively access property information from clearinghouse 40, purchase one or more shares of stock, submit a use request for a particular period of time, locate another shareholder to temporarily swap periods for use of the property, sell shares of stock, and/or receive an use assignment from clearinghouse 40.

In one embodiment, an electronic exchange is provided. Accordingly, and by way of example, a user at client 50 may selectively access a web page corresponding to the electronic exchange. Transactional information is then securely exchanged between client 50 and clearinghouse 40 to enable the purchase or sale of stock at the electronic exchange. Moreover, clearinghouse 40 may be accessed by a user to selectively determine the current price per share of the stock, the type of stock available for purchase, and the number of shares available.

While the discussion above provides a representative system configuration for implementing embodiments of the present invention, those skilled in the art will appreciate that the methods of the present invention and processes thereof may be implemented in a variety of different system configurations. Moreover, while FIG. 2 illustrates the electronic transfer of information relating to an entitlement to use, those skilled in the art will appreciate that other embodiments of the present invention embrace the exchange of information in person, by telephone, mail, facsimile, or electronically, including by electronic mail (“email”).

### Using Stock Shares to Entitle Use

As provided above, the present invention relates to providing entitlement rights to use a property. In particular, the present invention relates to selectively providing stock shares that entitle use.

Embodiments of the present invention embrace the creation of a company or corporation that owns one or more properties for use by individuals. The company gives up a portion of the ownership in the company through the issuing of stock, as will be discussed below. In accordance with embodiments of the present invention, ownership of stock entitles the stockholder with a right to use the property and/or any amenities of the property owned by the company.

In one embodiment, the company, or a management entity, oversees and selectively schedules use/occupancy according to benefits or dividends issued based on stock ownership. In a further embodiment, a schedule to use/occupy is created by receiving requests from stockholders and scheduling use/occupancy of the property according to which stockholder first made a request for the scheduled period of time. In another embodiment, a lottery system is used to assign use/occupancy dates or periods to the individual shareholders. In yet another embodiment, a preference to use dates/periods/amenities/properties is given based on the number of stock shares owned and/or based on ownership of a preferred stock.

Unlike prior art techniques that have proven to be expensive due to the sales expenses required, those sales expenses are greatly reduced when shares of stock in an entity are offered through traditional public or private offering techniques. In some embodiments, agents such as stockbrokers, or travel agents, or real estate agents forward offering circulars to interested clients and arrange for any subsequent sales or exchanges of stock. The value of the ownership in the entity can fluctuate with the market. Shares purchased immediately after declaration of the dividend or benefit will have a lower value. Because the initial price reflects the value of the property and is not inflated to cover marketing expenses, the property may not experience the immediate depreciation experienced with most timeshares.

In addition to participation in the traditional equity interests of stock ownership, the present invention anticipates the declaration of an annual benefit such as a dividend that conveys a right to use a property. This right to use can extend for a short period of time such as one week or for a longer period of time. The property and/or amenities may be the sole asset of the entity, or it can be one of several real estate or cruise ship or personal property assets. For example, an entity which traditionally has a long period before profitability such as a pharmaceutical company could purchase a vacation property. Purchasers of stock in the pharmaceutical company would be able to enjoy an annual weekly vacation on a cruise ship as a benefit or dividend for ownership of the pharmaceutical stock. This benefit to ownership would provide entertainment value to stocks, which traditionally do not attract some buyers.

Embodiments of the present invention embrace the use of a board of directors to make decisions for the company. The shareholders in the company meet periodically to determine the board. The board of directors hires the officers of the company (e.g., the president and other major officers), makes company decisions (e.g., the number of stock shares to issue, etc.), and establishes company policies. The board of directors allocates benefits or dividends. And, rather than distributing benefits or dividends to shareholders, the board of directors of the company may decide to allocate the dividends in other ways, including investing the dividends, purchasing more properties, hiring more employees, and/or otherwise expanding the company.

Embodiments of the present invention embrace either privately held or publicly held companies, wherein in a privately held company the shares of stock are owned by a small number of people that buy and sell their shares amongst themselves, and wherein a publicly held company is owned by thousands of people who trade their shares on a stock exchange.

The stock shares of a publicly traded company are bought and sold at a stock market or stock exchange. Examples of such markets include the New York Stock Exchange (“NYSE”), the American Stock Exchange (“AMEX”), and the National Association of Securities Dealers (“NASDAQ”). The publicly traded company lists its stock on an exchange to enable the buying and/or selling of shares. Furthermore, as provided herein, embodiments of the present invention embrace electronic stock exchanges that are available across a networked computer system to enable buying and/or selling of stock that entitles use of a property. The stock exchange enables an orderly market for buyers and sellers of its listed shares, and allows the price of a stock to be known throughout the business day. Accordingly, investors watch fluctuations in a stock's price.

Buy or sell orders at a public exchange are typically executed by stockbrokers who are members of the particular exchange. The stockbroker buys and/or sells stock on behalf of the investor. In one embodiment, when an investor contacts a broker, the broker relays the investor's trade to the floor of the appropriate exchange, and a representative of the company or a computer representing the company makes the trade on behalf of the investor. A commission may be paid to the broker for the service.

In accordance with embodiments of the present invention, individual stockholders are able to use the exchange, whether public or electronic, or are able to use a stockbroker in their behalf.

In other embodiments of the present invention, the stock shares are provided through one or more agents other than stockbrokers, including travel agents. In one embodiment, the travel agents are qualified to approach clients/customers regarding the purchase of stock shares, wherein as a dividend or benefit allocation the stockholder is able to use and/or occupy cruise ship property and/or amenities for a period of time, as will be further discussed below.

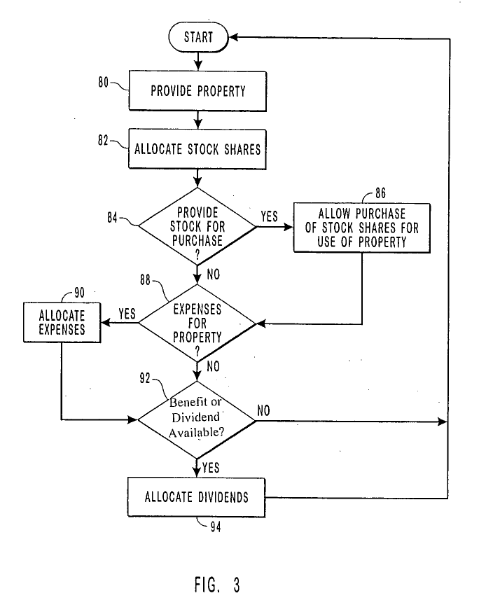

With reference now to FIG. 3, a flow chart is provided that illustrates a representative embodiment for allocating stock shares, expenses, and dividends relating to entitlements for use, including entitlements to occupy. In FIG. 3, execution begins at step 80 where a property is provided. Examples of the property include cruise ship property and/or amenities. The property is owned by the company and may be a single property (e.g., a single cruise ship or amenity) or a variety of properties (e.g., a plurality of cruise ships and/or amenities). At step 82, stock shares are allocated for the property. As provided above, the stock shares entitle use of the property that was provided in step 80.

Execution then proceeds to decision block 84 for a determination as to whether or not to provide stock for purchase. If it is determined at decision block 84 that stock is to be provided for purchase, execution proceeds to step 86 where the stock shares are made available for purchase. As provided herein, this may be at a public or electronic stock exchange or by word of mouth, or through an agent, such as a travel agent. Upon purchase of the stock, the stockholder is entitled to use the property for a period of time. Alternatively, if it is determined at block 84 that stock shares are not available for purchase, execution proceeds directly to decision block 88.

At decision block 88, a determination is made as to whether or not there exist expenses for the property. If it is determined at decision block 88 that expenses exist for the property, execution proceeds to step 90, where the expenses are allocated according to stock ownership, and then to decision block 92. Alternatively, if it is determined at decision block 88 that no expenses exist for the property, execution proceeds directly to decision block 92.

At decision block 92, a determination is made as to whether or not dividends are available for allocation. In one embodiment, a dividend is the right to use. In another embodiment, dividends are available where, for example, particular shares are not made available for purchase in order to allow for renting the property during the corresponding periods of time that are represented by the un-purchased stock shares. If it is determined at decision block 92 that no dividends are available for allocation, execution returns back to start. Alternatively, if it is determined at decision block 92 that dividends are available, execution proceeds to step 94 where the dividends are allocated according to stock share and then execution returns back to start.

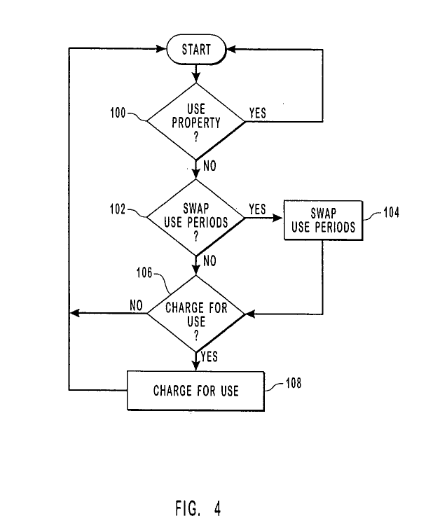

With reference now to FIG. 4, a flow chart is provided that illustrates a representative embodiment for selectively using rights obtained through the ownership of stock. For example, in FIG. 4 execution begins at decision block 100 for a determination as to whether or not the stockholder will use the property during a period of time for which the stockholder is scheduled for use of the property. If it is determined at decision block 100 that the stockholder will use the property, execution returns back to start.

Alternatively, if it is determined at decision block 100 that the stockholder will not use the property during the scheduled period of time, execution proceeds to decision block 102 for a determination as to whether or not the stockholder desires to swap use periods with another shareholder. The swapping of use periods is a temporary swap as opposed to an exchange or purchase of shares. Moreover, the swapping of use periods is an exchange between stockholders of time periods for which the stockholders are entitled to use the property.

Accordingly, if is it determined at decision block 102 that use periods corresponding to the shares are to be swapped, execution proceeds to step 104, where the use periods corresponding to the shares are swapped to entitle an exchange in the periods of time in which the use can occur for the stockholder. Execution then proceeds to decision block 106. Alternatively, if it is determined at decision block 102 that the stockholder does not desire to swap use periods corresponding to the shares or time periods, execution proceeds directly to decision block 106. This swapping of use periods is controlled in one embodiment by a professional property management company and is not directly managed by the entity. Some embodiments may incorporate management into the responsibilities of the board of the entity. In embodiments where a professional management company controls the actual date of use of the right conveyed by the declaration of dividends or benefits, then annual fees will be charged by the management company directly to the users. As a result, the value of the property may vacillate independently from the value of the entity. Although the value of the property will be indirectly reflected in the price of the stock of the entity, it may represent only a small portion of the value represented by the share price. For example, although the dividend or benefit may appeal to some purchasers, it may represent only a small portion of the price of a share of a large pharmaceutical company. An entity may wish to divorce itself from the potential variations in value of the vacation property by being responsible for a fixed contribution only and having the management company charge the user for any variations in user fees for maintenance, improvements, etc. In this embodiment, the benefit or dividend would take the form of a right to a reservation (e.g., a weekly reservation or other time period) at on a cruise ship for up to a fixed value. Any management fees above that value would be charged to the user. In situations where the property represents a large portion of the assets of the entity, the entity may simply wish to absorb increases and issue a benefit or dividend that incorporates the increases without additional cost to the user, or the entity may wish to keep the benefit or dividend constant and have the management company allocate increases directly to users.

At decision block 106, a determination is made as to whether or not to charge for use of the property during the time in which the stockholder is entitled to use the property, but will not be using the property. The illustrated embodiment embraces, for example, a stockholder renting out to another individual the right to take a cruise in the place of the stockholder during the time in which the stockholder is entitled to personally use the property (e.g., take the cruise). Accordingly, if it is determined at decision block 106 that the shareholder is not going to charge for use, then execution returns back to start. However, if it determined at decision block 106 that the shareholder will charge for use (e.g., rent out the property for the time period in which the stockholder is entitled to use the property), execution proceeds to step 108 where the charge is made for the use. Execution then returns back to start.

As provided above, embodiments of the present invention also embrace the right to use a property, including taking a cruise, as the benefit or dividend. In embodiments where a management company is employed to allocate costs of maintenance and improvements, an individual may choose not to participate in those costs and opt out of the benefit or dividend. This decision may be made due to personal financial situations or health issues. These stockholders will still benefit from ownership in the entity, but will not have any ongoing additional expenses from the management company. In a further embodiment, an option to not receive the benefit or dividend is for a period of time, and upon opting to not receive the dividend or benefit the managing company would attempt to rent out any extra rooms. If the management company could not successfully maintain the property at an acceptable occupancy level, the management company would notify the entity and the board of directors could issue more shares of stock. These additional shares would have dividends or benefits that would provide stockholders the opportunity to fill the cruise ship while simultaneously increasing the value of the outstanding shares. Accordingly, a vehicle is provided to generate a cash infusion to the company.

### Utilizing a Qualified Agent

As provided above, the present invention relates to providing entitlement rights to use a property, including to occupy a cabin (stateroom) and/or utilize amenities associated with a cruise. Further, at least some embodiments of the present invention relate to selectively providing stock shares that entitle use for purchase through an agent. Examples of such agents include a stockbroker, as provided above, a travel agent, and other such agents. Accordingly, embodiments of the present invention embrace the creation of a company or corporation that owns one or more properties (e.g., cruise ships, cruise ship cabins, amenities associated with cruise ships, and the like) for use by individuals. The company gives up a portion of the ownership in the company through the issuing of stock. Ownership of stock entitles the stockholder with a right to use the property and/or any amenities of the property owned by the company.

In some embodiments, where travel agents are employed to allow stock shares to be purchased, pre-qualified travel agents introduce the benefits of stock purchase to their clients/customers. In order to receive the advantage of a benefit or dividend, the clients purchase shares of stock. In one embodiment, the stock sales proceeds enables the purchase of designated cruise ship staterooms, amenities, etc. Vacation cruise credits are provided to shareholders as benefits or dividends. The vacation cruise credits are redeemable for cruise line vacations. Moreover, each year as a benefit or dividend the vacation cruise credits are issued as a dividend or benefit to stockholders in an amount proportionate to the shares of stock owned.

In some embodiments, the dividends are “points” that may be spent on a cruise ship or for an amenity that is associated with a cruise ship. For example, in one embodiment one share equals 10,000 points that may be used during a given year or time period. In one embodiment, the points may be used on a delayed basis. In another embodiment, the points may be saved and used at another time.

In one embodiment, all use is based on double occupancy on the cruise ship and/or in association with amenities of the cruise ship.

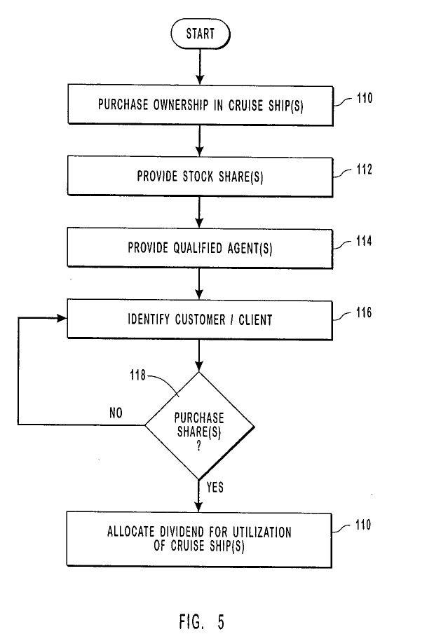

With reference now to FIG. 5, a flow chart is provided that illustrates a representative embodiment for providing, purchasing, and allocating stock shares through a travel agent for utilization of cruise ship property and/or amenities. In FIG. 5 execution begins at step 110, wherein ownership in cruise ship property and/or amenities is purchased by an entity. At step 112, stock shares are provided by the ownership entity. The stock shares are made available for purchase through agents, such as a pre-qualified travel agent provided at step 114.

The travel agent is used or employed to provide an opportunity for purchase of the stock shares. Accordingly, at step 116, a customer or client is identified and contacted by the travel agent, who explains the benefits of purchasing stock shares that entitle use. A decision is then made at decision block 118 as to whether or not the customer or client purchased one or more shares of the stock. If it is determined at decision block 118 that the customer or client did not purchase one or more shares of the stock, execution returns back to step 116 for the identification by the travel agent of another customer or client.

When it is determined that a customer or client has purchased one or more shares of stock, execution proceeds to step 110 for a dividend allocation that enables utilization of cruise ship property and/or amenities as provided herein.

In a further embodiment, the travel agent receives monies (e.g., a commission) and/or other incentives for the sale of stock shares.

Thus, as discussed herein, the embodiments of the present invention relate to providing stock shares having associated rights to a cruise. More particularly, the present invention relates to systems and methods for providing stock shares that represent ownership in at least a portion of one or more cruise ships by an entity, wherein the dividend or benefit of the stock shares entitles the stockholder rights to use the cruise ships (e.g., to occupy a cabin of one of the cruise ships during a cruise), and wherein the stock shares are sold through one or more qualified travel agents. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for providing equity ownership in an entity which has as an asset a cruise ship, the method comprising:
issuing stock shares in an entity which owns rights to use a cruise ship; and
declaring an annual dividend entitling the stockholder with a right to use the property for a fixed period.

2. A method as recited in claim 1, wherein the property corresponding to a cruise ship includes a right to an amenity of the cruise ship.

3. A method as recited in claim 2, wherein the amenity includes one of:
(i) access to a recreational facility;
(ii) access to a restaurant;
(iii) access to a club;
(iv) access to an exercise facility;
(v) access to a health spa and message therapy;
(vi) access to a personal hygiene salon;
(vii) use of transportation associated with the cruise ship;
(viii) an activity; and
(ix) a service.

4. A method as recited in claim 2, wherein the amenity is available on the cruise ship.

5. A method as recited in claim 2, wherein the amenity is available off of the cruise ship.

6. A method as recited in claim 1, wherein the step for issuing stock shares comprises at least one of the steps for:
(i) providing the stock shares for purchase through a travel agent and/or stock broker;
(ii) providing the stock shares at a public stock exchange;
(iii) providing the stock shares at an electronic exchange; and
(iv) privately providing the stock shares.

7. A method as recited in claim 1, wherein the stock shares include shares of a preferred stock.

8. A method as recited in claim 1, wherein the stock shares are issued in a plurality of classes and values.

9. A method as recited in claim 1, further comprising the step for selectively scheduling a use period to a stockholder.

10. A method as recited in claim 1, wherein the stock shares include a preferred stock.

11. A method as recited in claim 1, further comprising at least one of the steps for:
(i) allocating expenses; and
(ii) allocating dividends.

12. A method for using a property comprising:
purchasing stock that entitles use of at least one of:
a cruise ship property; and
an amenity associated with the cruise ship;
selectively obtaining a use period to exercise the use entitlement; and
using the property during the use period.

13. A method as recited in claim 12, wherein the step for purchasing stock is performed through a travel agent.

14. A method as recited in claim 12, wherein a benefit of the stock includes one or more points that are redeemable in association with the usage entitlement.

15. A method as recited in claim 14, further comprising the step for redeeming the points on a delayed basis.

16. A method as recited in claim 12, wherein the usage entitlement is based on double occupancy.

17. A method as recited in claim 12, wherein the step for selectively obtaining a use period comprises at least one of the steps for:
(i) providing a use request;
(ii) receiving the use period from a lottery system that assigns use periods; and
(iii) using a scheduling preference to obtain the use period.

18. A method as recited in claim 12, wherein the step for using the property during the use period comprises at least one of the steps for:
(i) swapping the use period for another use period; and
(ii) charging another individual to use the property during the use period.

19. A computer program product for implementing within a computer system a method for selectively obtaining an entitlement for use of a benefit associated with a cruise, the computer program product comprising:
a computer readable medium for providing computer program code means utilized to implement the method, wherein the computer program code means is comprised of executable code for implementing the steps for:
providing stock information that entitles use of at least one of:
a cruise ship property; and
an amenity associated with the cruise ship;
receiving purchase information from a user relating to a purchase of one or more shares of stock associated with the stock information; and
selectively preserving information corresponding to the purchaser of the one or more shares of stock.

20. A computer program product as recited in claim 19, wherein the user is a travel agent.

21. A method for providing equity ownership in an entity which has as an asset a right to use a part of a cruise ship, the method comprising:
issuing stock shares in an entity with rights to use a cruise ship; and
providing benefits entitling the stock share owner with a right to use a portion of the cruise ship for a fixed period.
